(19) United States
(12) Patent Application Publication
(10) Pub. No.: US 2025/0365346 A1
(43) Pub. Date: Nov. 27, 2025

(54) INFORMATION PROCESSING SYSTEM, SERVER APPARATUS, AND NON-TRANSITORY COMPUTER-READABLE RECORDING MEDIUM

(71) Applicant: KYOCERA DOCUMENT SOLUTIONS INC., OSAKA (JP)

(72) Inventors: DAIJIRO KITAMOTO, OSAKA (JP); MASAHIRO SUZUKI, OSAKA (JP); RYOTA YAGANE, OSAKA (JP)

(21) Appl. No.: 19/218,588

(22) Filed: May 26, 2025

(30) Foreign Application Priority Data
May 27, 2024 (JP) 2024-085434

(51) Int. Cl. H04L 67/2869; H04N 1/00

(52) U.S. Cl. CPC H04L 67/2869; H04N 1/00244; H04N 1/00347; H04N 1/00973; H04N 2201/0094

(57) ABSTRACT

An information processing system includes a first information processing apparatus, a server apparatus, and a second information processing apparatus. An export processing unit of the first information processing apparatus sends an export instruction, a first device number, and migration data to the server apparatus. An export management unit of the server apparatus receives and stores the export instruction, the first device number, and the migration data in association with each other. An import instruction unit of the second information processing apparatus sends an import instruction including the first device number to the server apparatus. An import management unit of the server apparatus receives the import instruction and sends the migration data to the second information processing apparatus. An import processing unit of the second information processing apparatus receives and records the migration data.

### CROSS-REFERENCE TO RELATED PATENT APPLICATION

This application claims the benefit of Japanese Priority Patent Application JP 2024-085434 filed May 27, 2024, the entire contents of which are incorporated herein by reference.

### FIELD OF THE DISCLOSURE

The present disclosure relates to an information processing system, a server apparatus, an information processing program, and a non-transitory computer-readable recording medium recording the information processing program that migrate data between information processing apparatuses.

### BACKGROUND OF THE DISCLOSURE

Migration data such as setting information is sometimes migrated between information processing apparatuses (e.g., image forming apparatuses such as multifunction peripherals (MFPs)). For example, when an information processing apparatus is replaced by another information processing apparatus, migration data of the information processing apparatus as a migration source is migrated to the information processing apparatus as a migration destination.

### SUMMARY OF THE DISCLOSURE

An information processing system according to an embodiment of the present disclosure includes a first information processing apparatus, a server apparatus, and a second information processing apparatus. The first information processing apparatus includes an export processing unit that sends an export instruction, a first device number, and migration data to the server apparatus, the first device number identifying the first information processing apparatus itself, the migration data being recorded on the first information processing apparatus and being a migration target. The server apparatus includes an export management unit that receives the export instruction, the first device number, and the migration data from the first information processing apparatus and stores the first device number and the migration data in association with each other on a storage medium. The second information processing apparatus includes an import instruction unit that sends an import instruction including the first device number to the server apparatus. The server apparatus further includes an import management unit that receives the import instruction from the second information processing apparatus and sends the migration data associated with the first device number included in the import instruction to the second information processing apparatus. The second information processing apparatus further includes an import processing unit that receives the migration data from the server apparatus and records the migration data on the second information processing apparatus.

A server apparatus according to an embodiment of the present disclosure includes an export management unit and an import management unit. The export management unit receives an export instruction, a first device number, and migration data from a first information processing apparatus that sends the export instruction, the first device number, and the migration data to the server apparatus, the first device number identifying the first information processing apparatus itself, the migration data being recorded on the first information processing apparatus and being a migration target. The export management unit stores the first device number and the migration data in association with each other on a storage medium. The import management unit receives the import instruction from a second information processing apparatus that sends an import instruction including the first device number to the server apparatus. The import management unit sends the migration data associated with the first device number included in the import instruction to the second information processing apparatus.

An information processing program recorded on a non-transitory computer-readable recording medium according to an embodiment of the present disclosure causes a computer for a server apparatus to operate as an export management unit and an import management unit. The export management unit receives an export instruction, a first device number, and migration data from a first information processing apparatus that sends the export instruction, the first device number, and the migration data to the server apparatus, the first device number identifying the first information processing apparatus itself, the migration data being recorded on the first information processing apparatus and being a migration target. The export management unit stores the first device number and the migration data in association with each other on the storage medium. The import management unit receives the import instruction from a second information processing apparatus that sends the import instruction including the first device number to the server apparatus. The import management unit sends the migration data associated with the first device number included in the import instruction to the second information processing apparatus.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 shows an information processing system according to an embodiment of the present disclosure.

FIG. 2 shows a hardware configuration of an image forming apparatus used as an information processing apparatus.

FIG. 3 shows a functional configuration of the information processing system.

FIG. 4 shows a sequence of sending migration data to a server apparatus from a first information processing apparatus (migration source).

FIG. 5 shows a flowchart of sending the migration data to the server apparatus from the first information processing apparatus (migration source).

FIG. 6 shows a sequence of a second information processing apparatus (migration destination) receiving the migration data from the server apparatus.

FIG. 7 shows a flowchart of the second information processing apparatus (migration destination) receiving the migration data from the server apparatus.

### DETAILED DESCRIPTION OF THE EXEMPLARY EMBODIMENTS

Hereinafter, embodiments of the present disclosure will be described below with reference to the drawings.

### 1. INFORMATION PROCESSING SYSTEM

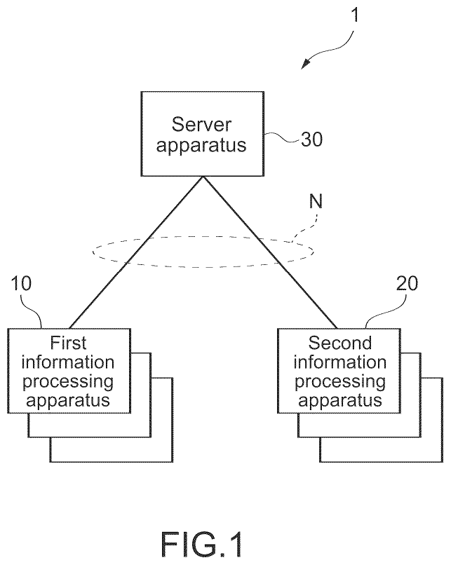

FIG. 1 shows an information processing system according to an embodiment of the present disclosure.

An information processing system 1 includes at least one first information processing apparatus 10, at least one second information processing apparatus 20, and a server apparatus 30. The at least one first information processing apparatus 10, the at least one second information processing apparatus 20, and the server apparatus 30 are connected to a network, e.g., the Internet, and they are capable of communicating with each other.

The first information processing apparatus 10 and the second information processing apparatus 20 may be image forming apparatuses, e.g., multifunction peripherals (MFPs). However, the first information processing apparatus 10 and the second information processing apparatus 20 are not limited to the MFPs. Any electronic apparatuses may be employed as long as they are of the same type and capable of communicating.

In the present embodiment, when an information processing apparatus is replaced by another information processing apparatus, migration data of the information processing apparatus as a migration source is migrated to the information processing apparatus as a migration destination. The first information processing apparatus 10 is an old apparatus as the migration source (before replacement) and the second information processing apparatus 20 is a new apparatus as the migration destination (after replacement). The migration data is, for example, setting information of the first information processing apparatus 10. For example, the migration data includes setting data for defining operations of the first information processing apparatus 10, an address book relating to a user who uses the first information processing apparatus 10 and business partner users (e.g., sending sources of FAX and mail), image data accumulated by each user, and the like.

### 2. HARDWARE CONFIGURATION OF IMAGE FORMING APPARATUS

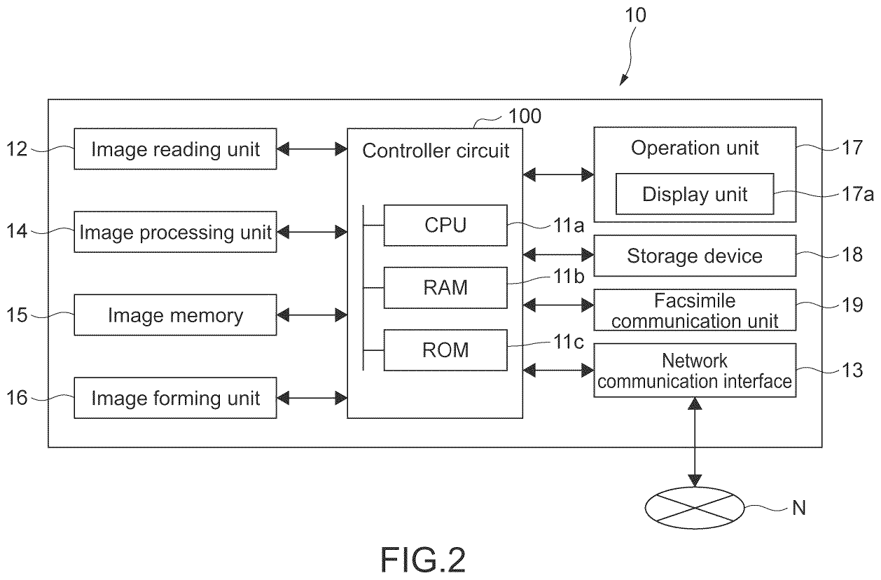

FIG. 2 shows a hardware configuration of an image forming apparatus used as an information processing apparatus.

In a case where the first information processing apparatus 10 and the at least one second information processing apparatus 20 are image forming apparatuses, they have similar hardware configurations. Therefore, a hardware configuration of one image forming apparatus 10 will be described as a representative.

The image forming apparatus 10 includes a control circuit 100 that constitutes a computer. The control circuit 100 is constituted by a central processing unit (CPU) 11a, which is a processor, a random access memory (RAM) 11b, a read only memory (ROM) 11c, which is a memory, a dedicated hardware circuit, and the like. The control circuit 100 serves to comprehensively control the operation of the image forming apparatus 10. By loading the information processing program stored on the ROM 11c to the RAM 11b and executing the information processing program, the CPU 11a executes an operation described in the following operation flow and controls the display and operation input on a touch panel 17. The ROM 11c permanently stores the program, data, and the like executed by the CPU 11a. The ROM 11c is an example of a non-transitory computer-readable recording medium.

The control circuit 100 is connected to an image reading unit 12 (image scanner), an image processing unit 14 (including graphics processing unit (GPU)), an image memory 15, an image forming unit 16 (printer), a touch panel (front panel) 17, which is an operation unit including a display unit 17a, a large-volume non-volatile storage device 18, such as a hard disk drive (HDD) or a solid state drive (SSD), a facsimile communication unit 19, a network communication interface 13 (communication unit), and the like. The control circuit 100 controls the operations of the above-mentioned respective parts connected and exchanges signals and data with the respective parts. The operation unit of the touch panel 17 is an embodiment of an input device. An audio input device including a microphone may be provided as the input device.

### 3. FUNCTIONAL CONFIGURATION OF INFORMATION PROCESSING SYSTEM

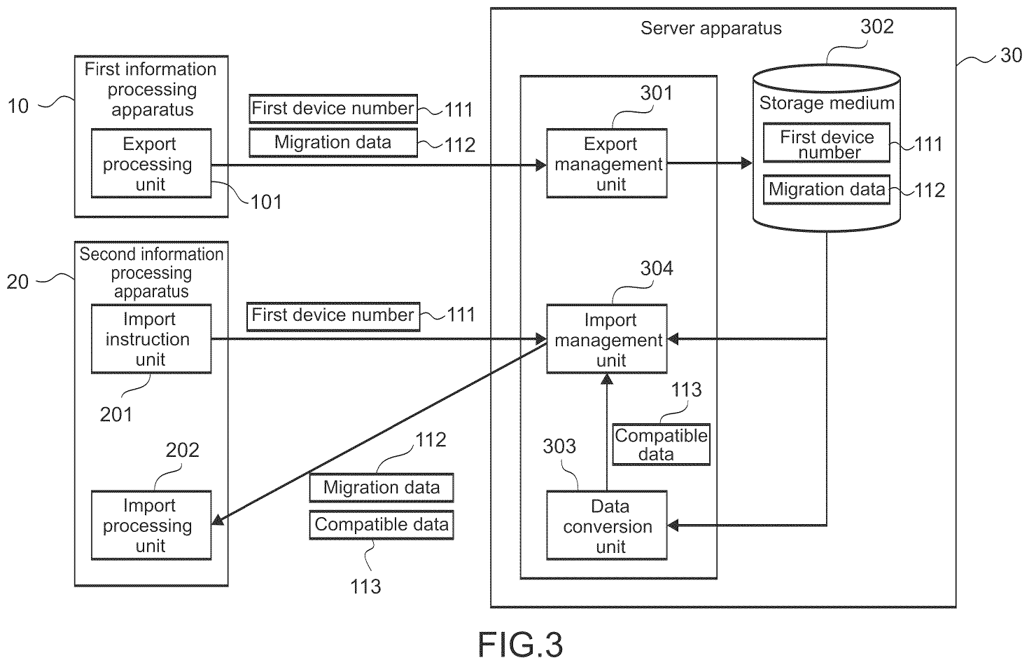

FIG. 3 shows a functional configuration of the information processing system.

The first information processing apparatus 10 operates as an export processing unit 101 by the computer executing the information processing program. The second information processing apparatus 20 operates as an import instruction unit 201 and an import processing unit 202 by the computer executing the information processing program. The server apparatus 30 operates as an export management unit 301, a data conversion unit 303, and an import management unit 304 by the computer executing the information processing program.

### 4. OPERATION OF INFORMATION PROCESSING SYSTEM

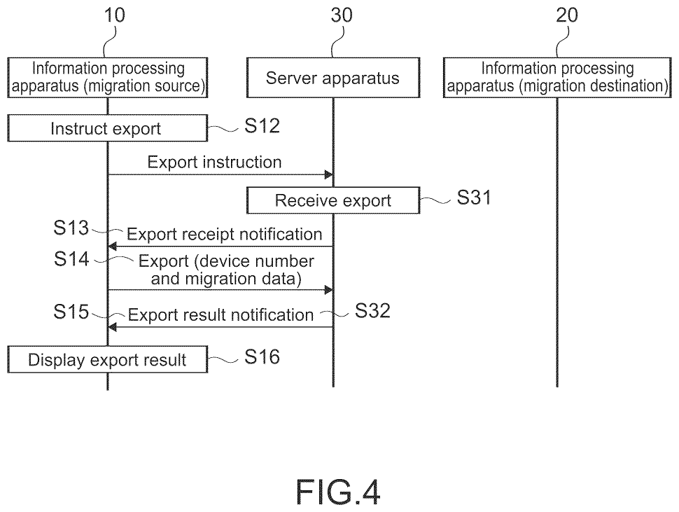

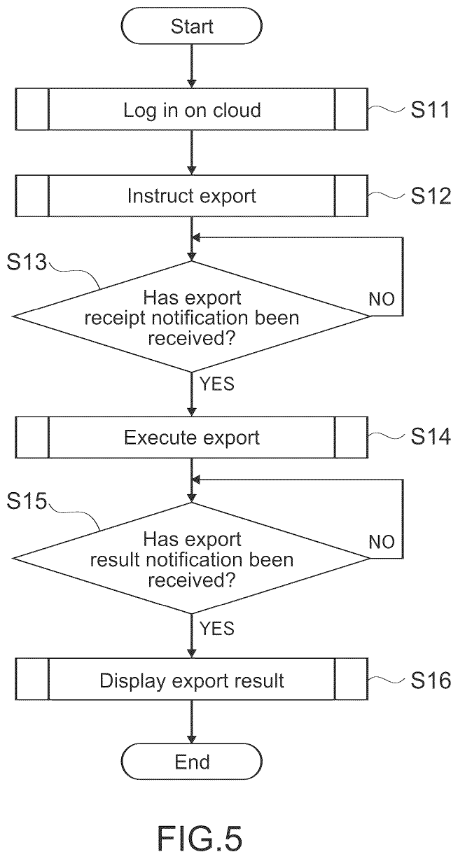

FIG. 4 shows a sequence of sending the migration data to the server apparatus from a first information processing apparatus (migration source). FIG. 5 shows a flowchart of sending the migration data to the server apparatus from the first information processing apparatus (migration source).

The user operates the touch panel 17 of the first information processing apparatus 10 as the migration source (before replacement) or a mobile device (e.g., a smartphone) to log in the server apparatus 30 on a cloud (Step S11). The export processing unit 101 of the first information processing apparatus 10 sends an export instruction to the server apparatus 30 (Step S12).

The export management unit 301 of the server apparatus 30 receives the export instruction from the first information processing apparatus 10 and sends an export receipt notification to the first information processing apparatus 10 (Step S31).

When the export processing unit 101 of the first information processing apparatus 10 receives the export receipt notification from the server apparatus 30 (YES in Step S13), the export processing unit 101 executes the export. Specifically, the export processing unit 101 sends a first device number 111 (e.g., an IP address) identifying the first information processing apparatus 10 itself, and migration data 112, which is recorded on the first information processing apparatus 10 and is a migration target, to the server apparatus 30 (Step S14).

The export management unit 301 of the server apparatus 30 receives the first device number 111 and the migration data 112 from the first information processing apparatus 10. The export management unit 301 stores the first device number 111 and the migration data 112 in association with each other on a storage medium 302 and sends an export result notification to the first information processing apparatus 10 (Step S32). The export result notification indicates a success or failure of receipt and storage of the first device number 111 and the migration data 112.

When the export processing unit 101 of the first information processing apparatus 10 receives the export result notification from the server apparatus 30 (YES in Step S15), the export processing unit 101 displays the export result notification on, for example, the touch panel 17 or the mobile device (Step S16). In a case where the export result notification indicates the success, the export processing unit 101 closes the export job. In a case where the displayed export result notification indicates the failure, the user retries from Step S11.

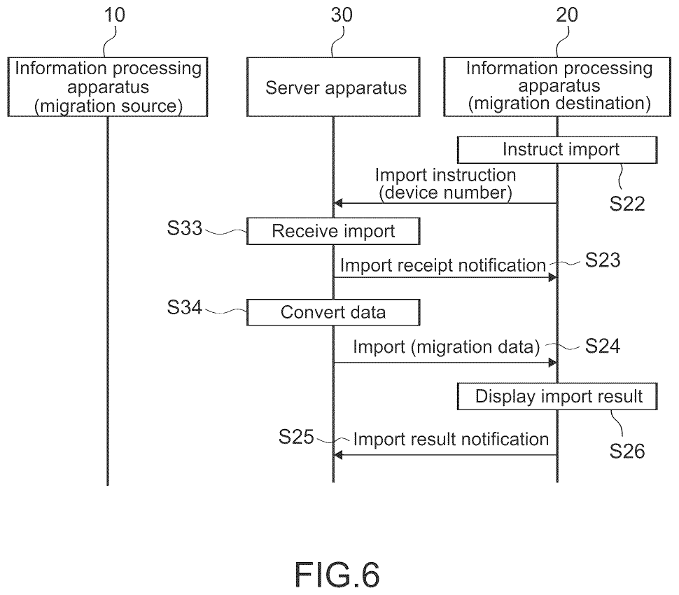

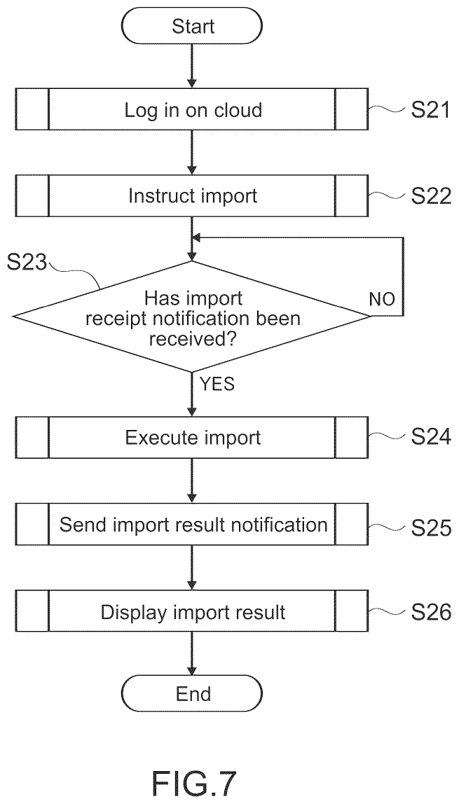

FIG. 6 shows a sequence of a second information processing apparatus (migration destination) receiving the migration data from the server apparatus. FIG. 7 shows a flowchart of the second information processing apparatus (migration destination) receiving the migration data from the server apparatus.

The user operates the touch panel 17 of the second information processing apparatus 20 as the migration destination (after replacement) or the mobile device to log in the server apparatus 30 on the cloud (Step S21). The user inputs into the second information processing apparatus 20 the first device number 111 identifying the first information processing apparatus 10 that is the migration source. For example, the user only needs to send the first device number 111 to the second information processing apparatus 20 from the mobile device or to connect a USB memory on which the first device number 111 has been recorded to the second information processing apparatus 20 and send the first device number 111 to the second information processing apparatus 20. The import instruction unit 201 of the second information processing apparatus 20 sends an import instruction to the server apparatus 30 (Step S22). The import instruction includes the first device number 111 identifying the first information processing apparatus 10 that is the migration source.

The import management unit 304 of the server apparatus 30 receives the import instruction from the second information processing apparatus 20 and sends an import receipt notification to the second information processing apparatus 20 (Step S33).

The import instruction unit 201 of the second information processing apparatus 20 receives the import receipt notification from the server apparatus 30 (YES in Step S23).

In a case where a device type (device type of the first information processing apparatus 10) identified by the first device number 111 is different from a device type (the second information processing apparatus 20) identified by a second device number identifying the second information processing apparatus 20, the data conversion unit 303 of the server apparatus 30 generates compatible data 113 by converting the migration data 112 so that the migration data 112 is compatible with the device type identified by the second device number (Step S34). It should be noted that the server apparatus 30 only needs to acquire the second device number identifying the second information processing apparatus 20 from the information about the login on the cloud (Step S21). Alternatively, the second device number identifying the second information processing apparatus 20 may be included in the import instruction (Step S22) from the second information processing apparatus 20.

The import management unit 304 of the server apparatus 30 sends to the second information processing apparatus 20 the migration data 112 (in a case where the device types are the same) or the converted compatible data 113 (in a case where the device types are different) associated with the first device number 111 included in the import instruction from the second information processing apparatus 20.

The import processing unit 202 of the second information processing apparatus 20 receives the migration data 112 or the compatible data 113 from the server apparatus 30 and records (imports) the migration data 112 or the compatible data 113 on the second information processing apparatus 20 (Step S24). When the import is completed, the import processing unit 202 sends an import result notification to the server apparatus 30 (Step S25) and displays the import result notification on, for example, the touch panel 17 or the mobile device (Step S26). The order of Steps S25 and S26 is not limited. In a case where the import result notification indicates the success, the server apparatus 30 closes the import job. In a case where the displayed import result notification indicates the failure, the user retries from Step S21.

### 4. CONCLUSION

According to the related technology, it is necessary to input and retain a device number of an information processing apparatus as a migration destination by an information processing apparatus as a migration source of migration data. Therefore, if there are a large number of information processing apparatuses as migration destinations, the user needs to input a large number of device numbers through an information processing apparatus as a migration source, and it takes time and effort for the user.

On the other hand, according to the present embodiment, the second information processing apparatus 20, which is a migration destination, retains the first device number 111 of the first information processing apparatus 10, which is a particular migration source. The first information processing apparatus 10, which is at least one migration source, sends the migration data 112 and the first device number 111 of the migration source to the server apparatus 30. The server apparatus 30 stores the first device number 111 of the first information processing apparatus 10 as the at least one migration source and the migration data 112 in association with each other. During the data migration, the second information processing apparatus 20 as the migration destination sends the first device number 111 of the first information processing apparatus 10 as the particular migration source to the server apparatus 30. The second information processing apparatus 20 as the migration destination receives from the server apparatus 30 the migration data associated with the first device number 111 of the first information processing apparatus 10 as the particular migration source.

Accordingly, the user does not need to input the device number of the information processing apparatus as the migration destination by the information processing apparatus as the migration source. Thus, the user's time and effort can be saved especially in a case of migrating the migration data of the first information processing apparatus 10 as the migration source to a plurality of second information processing apparatuses 20 as migration destinations.

Although each embodiment and each modified example of the present technology have been described above, the present technology is not limited to the above-mentioned embodiments, and various modifications can be made without departing from the gist of the present technology as a matter of course.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing system, comprising:
a first information processing apparatus including an export processing unit that sends an export instruction, a first device number, and migration data to a server apparatus, the first device number identifying the first information processing apparatus itself, the migration data being recorded on the first information processing apparatus and being a migration target;
the server apparatus including an export management unit that receives the export instruction, the first device number, and the migration data from the first information processing apparatus and stores the first device number and the migration data in association with each other on a storage medium; and
a second information processing apparatus including an import instruction unit that sends an import instruction including the first device number to the server apparatus, wherein
the server apparatus further includes an import management unit that receives the import instruction from the second information processing apparatus and sends the migration data associated with the first device number included in the import instruction to the second information processing apparatus, and
the second information processing apparatus further includes an import processing unit that receives the migration data from the server apparatus and records the migration data on the second information processing apparatus.

2. The information processing system according to claim 1, wherein
the server apparatus further includes a data conversion unit that generates, in a case where a device type identified by the first device number is different from a device type identified by a second device number identifying the second information processing apparatus, compatible data by converting the migration data so that the migration data is compatible with the device type identified by the second device number,
the import management unit of the server apparatus sends the compatible data to the second information processing apparatus, and
the import processing unit of the second information processing apparatus receives the compatible data and records the compatible data on the second information processing apparatus.

3. The information processing system according to claim 1, further comprising
a plurality of the second information processing apparatuses.

4. A server apparatus, comprising:
an export management unit that
receives an export instruction, a first device number, and migration data from a first information processing apparatus that sends the export instruction, the first device number, and the migration data to the server apparatus, the first device number identifying the first information processing apparatus itself, the migration data being recorded on the first information processing apparatus and being a migration target, and
stores the first device number and the migration data in association with each other on a storage medium; and
an import management unit that
receives the import instruction from a second information processing apparatus that sends an import instruction including the first device number to the server apparatus, and
sends the migration data associated with the first device number included in the import instruction to the second information processing apparatus.

5. A non-transitory computer-readable recording medium recording an information processing program that causes a computer for a server apparatus to operate as:
an export management unit that
receives an export instruction, a first device number, and migration data from a first information processing apparatus that sends the export instruction, the first device number, and the migration data to the server apparatus, the first device number identifying the first information processing apparatus itself, the migration data being recorded on the first information processing apparatus and being a migration target, and
stores the first device number and the migration data in association with each other on the storage medium; and
an import management unit that
receives the import instruction from a second information processing apparatus that sends the import instruction including the first device number to the server apparatus, and
sends the migration data associated with the first device number included in the import instruction to the second information processing apparatus.
